(19) United States
(12) Patent Application Publication
(10) Pub. No.: US 2013/0290851 A1
(43) Pub. Date: Oct. 31, 2013

(54) USER INTERFACE WEB SERVICES

(71) Applicant: MICROSOFT CORPORATION, Redmond, WA (US)

(72) Inventor: Michael Helligso Svinth, Taastrup (DK)

(73) Assignee: MICROSOFT CORPORATION, Redmond, WA (US)

(21) Appl. No.: 13/650,147

(22) Filed: Oct. 12, 2012

Related U.S. Application Data
(60) Provisional application No. 61/640,305, filed on Apr. 30, 2012.

(51) Int. Cl. G06F 3/01; G06F 15/16

(52) U.S. Cl. 715/733

(57) ABSTRACT

User interface web services are provided. In one embodiment, a user interface web service includes a control structure, a communications interface, and a processor. The control structure is utilized to facilitate generation of a device dependent user interface. The communication interface receives an indication of an interaction with the device dependent user interface, and the processor generates a delta in response to the interaction. The control structure may be organized hierarchically, and the delta may identify a change to the control structure, metadata, state, or other data associated with the device dependent user interface. Additionally, the delta may include information about the flow of a UI such as, but not limited to, which page, dialogs, etc. are shown to the user.

### REFERENCE TO RELATED CASE

The present application is based on and claims the benefit of U.S. provisional patent application Ser. No. 61/640,305, filed Apr. 30, 2012, the content of which is hereby incorporated by reference in its entirety.

### BACKGROUND

It is becoming increasingly desirable for enterprise resource planning (ERP) applications and other business functionality applications to be conveniently operable in multiple different environments. For example, in some circumstances, it may be desirable for an application to be installed on a hard drive of a computer such that the data is readily available. However, in other circumstances, it may also or alternatively be desirable to have the application available over a network (e.g., the Internet), in which case the application would not necessarily be installed on every hard drive of every computer that is using the application.

A web service component is sometimes utilized to facilitate the process of providing business application functionality over a network. The web service in many cases is data record oriented and often is focused on supporting integration with other specific systems (e.g., different metadata assumptions for different systems, etc.). The application components exposed by the web service are often limited to forms and tables. In many cases, a limited set of operations are exposed to developers so that they can manage record handling operations such as create, read, update, and delete operations. The limitations presented by the web service component are not ideal for building or supporting a rich user interface. Nor are they ideal for building or supporting user interfaces that are ideal or optimized for any of a large variety of different hardware devices and platforms utilized to support access of the application over the network.

The discussion above is merely provided for general background information and is not intended to be used as an aid in determining the scope of the claimed subject matter.

### SUMMARY

An aspect of the disclosure relates to user interface web services. In one embodiment, a user interface web service includes a control structure, a communications interface, and a processor. The control structure is utilized to facilitate generation of a device dependent user interface. The communication interface receives an indication of an interaction with the device dependent user interface, and the processor generates a delta in response to the interaction. The control structure may be organized hierarchically, and the delta may identify a change to the control structure, metadata, state, or other data associated with the device dependent user interface. Additionally, the delta may include information about the flow of a UI such as, but not limited to, which page, dialogs, etc. are shown to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of a user interface system.

FIG. 2 is a block diagram of a user interface service server.

FIG. 3 is a block diagram illustrating interactions between a user interface service server and a client device.

FIG. 4 is a block diagram of a control structure.

FIG. 5 is a block diagram showing modules of a user interface system.

FIG. 6 is a block diagram of internal components of a tablet device.

FIG. 7 is a block diagram of external components of a tablet device.

FIG. 8 is a block diagram of a mobile phone.

FIG. 9 is a block diagram of a personal digital assistant.

FIG. 10 is a block diagram of a computer.

FIG. 11 shows a block diagram of illustrative cloud computing architectures.

### DETAILED DESCRIPTION

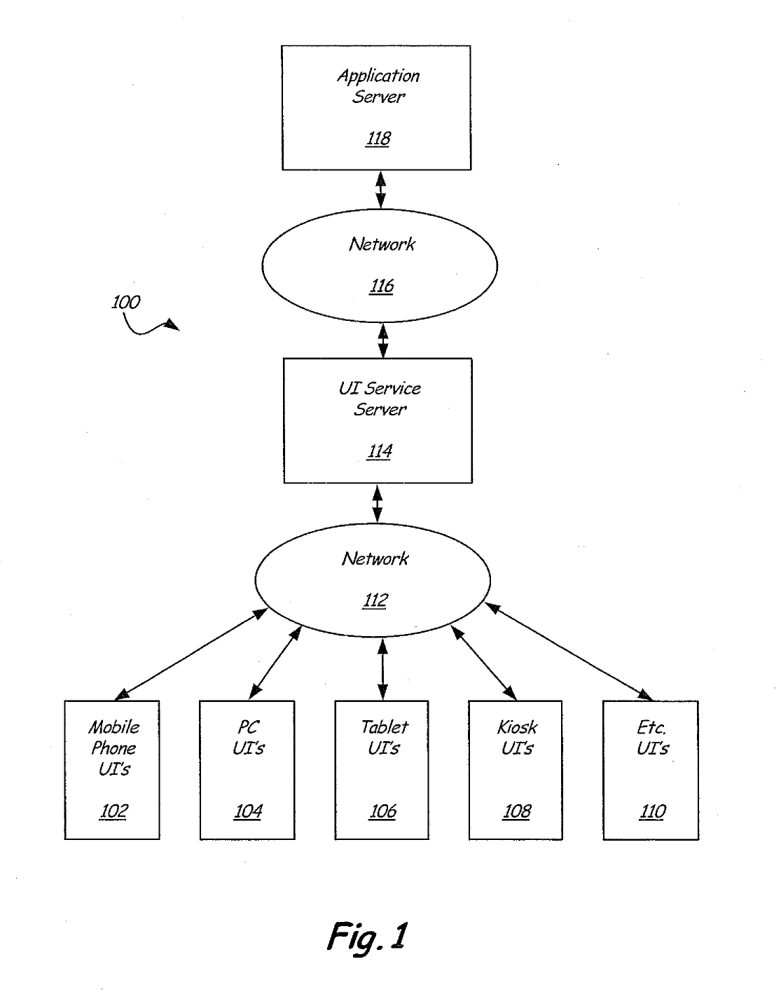

FIG. 1 is a block diagram of one illustrative user interface system 100. FIG. 1 shows that system 100 includes user interface displays 102-110. In one embodiment, user interface displays 102-110 have associated user input mechanisms for receiving inputs from a user so that the user can, to some extent, interact with and control system 100. Displays 102-110 and their associated input mechanisms can be implemented in the context of any of a variety of different end user hardware devices including but not limited to devices for providing inputs using a point and click device, a keyboard, touch gestures, voice, etc. System 100 may include any number of end user hardware devices with associated displays having different form factors. For illustrative purposes only, display 102 is suggested as being implemented on a mobile phone, display 104 on a desktop or other personal computer, display 106 on a tablet computer, display 108 on a kiosk system, and display 110 is illustrated as a catchall representing any and all other computing devices.

The end user hardware devices upon which displays 102-110 are implemented are shown in communication over a network 112 with a user interface service server 114 (UI service server 114). The UI service server 114 is then shown in communication over a network 116 with an application server 118. As will become apparent, the UI server 114 facilitates the creation of displays 102-110, though the displays are ultimately rendered primarily by their associated hardware devices—based in part on information received from the server 114. The displays are illustratively interfaces to the application associated with the application server 118 and, as such, illustratively incorporate application data derived from the application server 118 or a closely associated data source. The UI server 114 interacts with the application server 118 in order to identify application data and/or other information to be integrated into the displays 102-110 when the UI server facilitates the generation of the displays 102-110.

It is to be understood that networks 112 and 116 may be the same network (e.g., the Internet) or they may be different networks. It is also within the scope of the present invention for communication between system 100 components to be effectuated without network facilitation. For example, but not by limitation, application server 118 and UI server 114 may be implemented on the same computing device, thereby making communication over network 116 unnecessary. Similarly, application server 118 and/or UI service server 114 could be implemented on a computing device associated with a display 102-110, thereby making network communication unnecessary to some extent.

In one embodiment, UI server 114 is implemented as part of a scalable system wherein the server 114 essentially functions as an agent of multiple applications. In this case, the server 114 facilitates generation of displays 102-110 for multiple different applications implemented on one or more application servers 118. Some examples of possible applications include, but are not limited to, enterprise resource planning (ERP) applications, customer resource management (CRM) applications, line-of-business (LOB) applications, and/or any other business system or application. Thus, the UI server 114 concurrently supports the generation of end user displays for any number of different end user devices and platforms, and does so for essentially any number of applications on any number of application servers 118. Of course, system 100 can also incorporate any number of UI servers 114 that are associated with any number of application servers 118. The precise configuration that is most desirable will vary depending at least upon system requirements and specifications.

For the purpose of simplification, it will be assumed that UI service server 114 facilitates the rendering of displays 102-110 in conjunction with a single application associated with application server 118. For the purposes of illustration, it will be assumed that the application is a business data system, in particular an ERP system. For the ERP application, server 118 illustratively includes access to one or more related application data sources. Application server 118 manages the ERP application data and responds to requests by delivering the data the UI service server 114, so as to support the UI web server in its facilitation of the rendering of displays 102-110 primarily by the end user hardware devices based at least in part on information received from the UI service server 114.

A traditional web service interface to a business data system like an ERP application is typically focused primarily on data operations (e.g., create, read, update, and delete operations) or business process operations. Such a scenario is not optimal for building a complete and flexibly accessible application user interface, as such a user interface generally requires specific constructs (e.g., platform specific constructs) that are not supported in the provided web services. Examples include details related to the flow of the user interface, which is to show a sequence of pages due to user actions, bringing up model dialogs for asking the user for input needed for the process, showing value lookup dialogs, etc.

In contrast to a traditional web service interface, the user interface (UI) exposed by the UI service server 114 illustratively includes access to a collection of UI constructs for building UI clients, for example, building displays 102-110 for the business application associated with application server 118. The UI constructs include, not by limitation, support for the user interface flow, designations as to which pages will be made part of the display and under what circumstances this will occur, and designations as to which dialogs will be made part of the display and under what circumstances this will occur. In one embodiment, the displays 102-110 are based on the same or substantially similar application development model/tools and are configured to share the same metadata. The web service provided in conjunction with the UI service server 114 exposes a logical UI that is rendered on the particular device and platform associated with each of the respective displays 102-110. Thus, the provided infrastructure enables displays 102-110 with rich user interface functionality on any of the devices or platforms with which the displays are implemented.

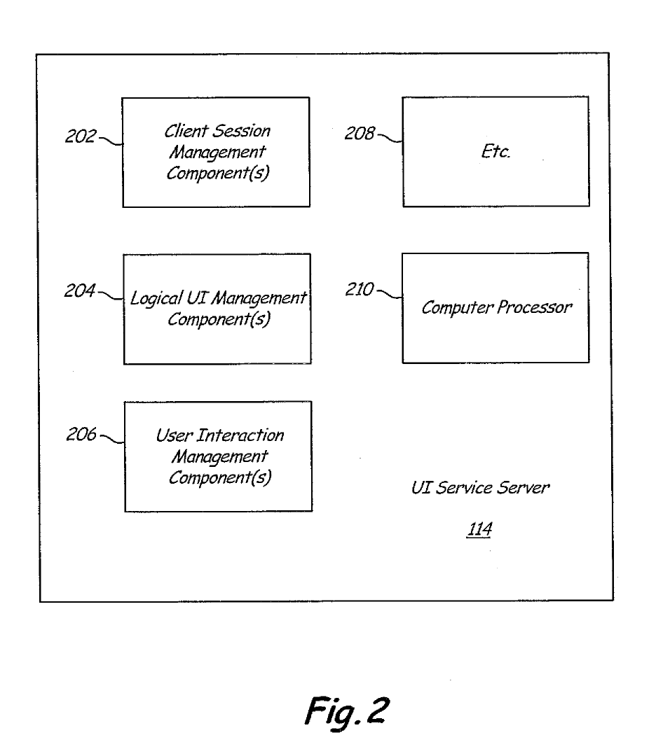

FIG. 2 is a block diagram of a more detailed depiction of UI service server 114 showing some of the specific components that enable it to operate within system 100 by exposing a logical UI representation as part of its provided web services. A client session management component 202 is illustratively configured to support the opening and closing of client sessions with different client devices upon which service server 114 facilitates creation of the displays 102-110. A logical UI management component 204 is illustratively configured to support requests for logical representations (e.g., representations of a page) including the handling information regarding fields, buttons, field/button data, and state (e.g., is the field visible, editable, etc.) and any other similar user interface characteristics. A user interaction management component 206 is illustratively configured to support the execution of user level interactions on the logical representation of the UI (e.g., the logical pages). The result of these calls is illustratively a collection of changes that have happened in the logical UI representation including data/state changes. In one embodiment, the result also includes information regarding flow changes in the UI such as indications when a page is closed, when a new page/dialog/lookup is shown, etc. Block 208 is a catchall demonstrating the fact that UI service server component 114 may include other functional components in addition to those specifically included for demonstrating embodiments within the scope of the present invention.

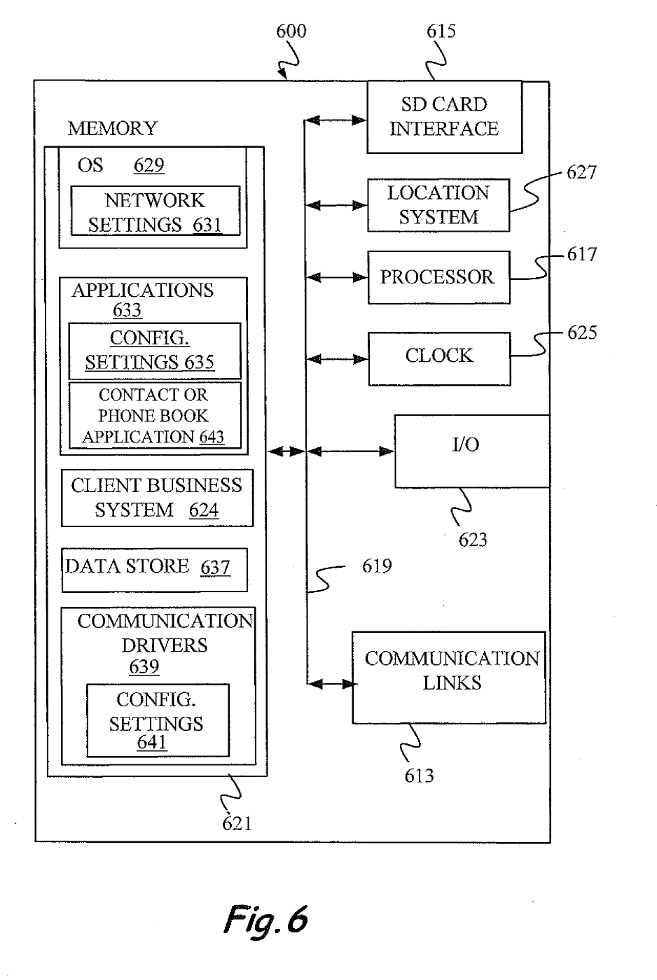

FIG. 2 also shows that UI service server 114 includes a computer processor 210. Computer processor 210 is illustratively a functional part of a computer and is associated with memory and timing circuitry. The processor 210 and its associated circuitry may be activated by and facilitate the functionality of the other components (e.g. components 202, 240, 206, and/or 208). Furthermore, it should be noted that any one or more of the other systems shown in the figures or described in the specification may similarly include a computer processor. For instance, devices 102, 104, 106, 108, 110, 114, and/or 118 in FIG. 1 may include processors, and each of the devices shown in FIGS. 6-11 may also include one or more computer processors.

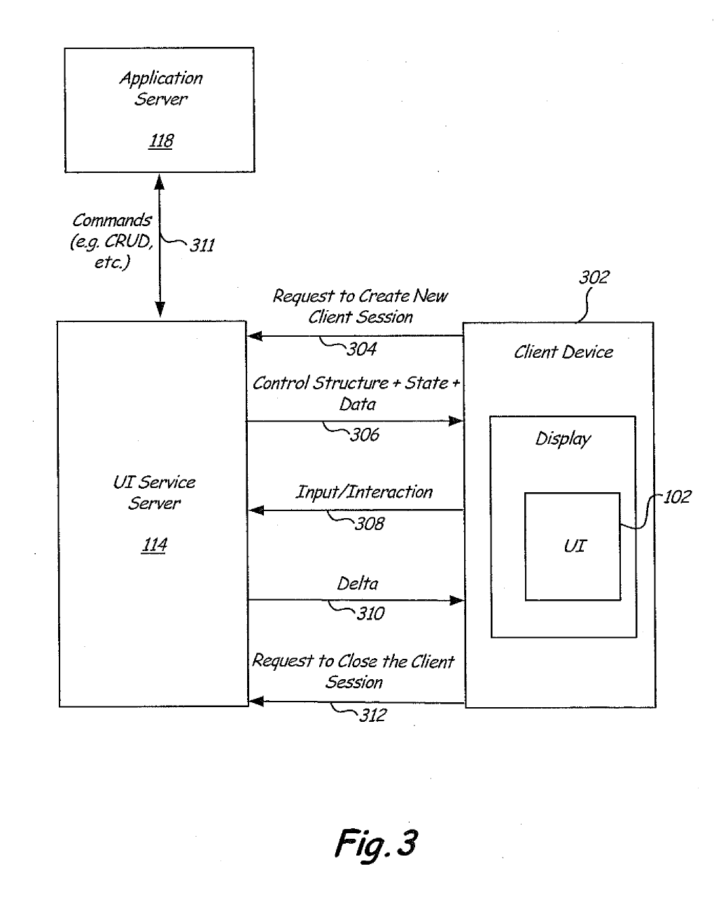

FIG. 3 is a schematic diagram demonstrating, in one embodiment of the present invention, illustrative interactions between the UI service server 114 and a device 302 (e.g. a client device) upon which the user interface 102 is displayed. In this example, the interactions are not illustrated as being carried out over a network. However, as was discussed in relation to FIG. 1, such a scenario is contemplated.

At line 304, the client 302 sends a request to the UI service server 114 to create a new client session. In response to the request, the UI service server 114 sends the client 302 UI information at line 306. The UI information illustratively includes any information that may be used by the client 302 in rendering a UI. For instance, the UI information may include a logical user interface that has a control structure, state information, data, metadata, etc. In one embodiment, the UI information includes information for generating UIs on devices having different form factors, screen sizes, screen resolutions, etc. Accordingly, the same UI information can be sent to a number of different client devices. The client devices then use the information to render a UI that is appropriate for its display. In other words, the client device will render a UI based at least in part on its display properties. In another embodiment however, different variations of the UI information can be sent to different devices to generate the UI's.

Once the client device 302 has rendered a UI 102, a user interacts with the UI 102 (e.g. inputs a value, performs a function, requests information, etc.), and the client device 302 sends an indication of the interaction at line 308 to the UI service server 114. The UI service server 114 uses the information to determine one or more deltas. A delta illustratively represents a change in the UI 102 that is responsive to the user interaction. For example, a delta may identify a change to data, metadata, a control structure, etc. The one or more deltas are sent to the client device 302 at line 310.

In calculating the delta, the UI service server 114 may need to interact with Application server 118, which is indicated by line 311. For instance, the application server 118 may translate or convert the input/interaction 308 from the user into a CRUD command that is transmitted to the application server 118. The UI service server 114 can use the application server's response to the CRUD command in generating a delta for transmission to the client device.

Finally with respect to FIG. 3, client device 302 may indicate a request to close the current session at line 312. UI service server 114 uses the request to close down any needed session information, and perhaps to free resources for other sessions/clients.

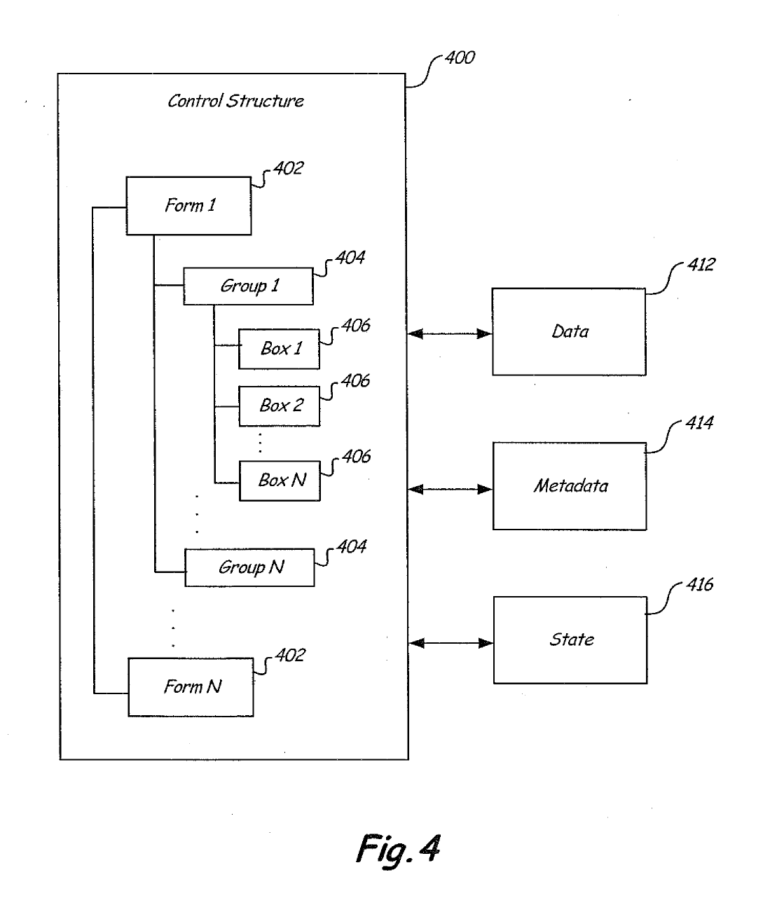

FIG. 4 is a block diagram of a control structure. As was indicated in FIG. 3 above, a UI service server 114 may transmit a control structure that is utilized in generating a UI 102. In one embodiment, the control structure is a hierarchically organized control structure. For instance, in the particular example shown in FIG. 4, control structure 400 includes any number of forms 402 at a top or first level. Beneath the forms in the control structure are any number of groups 404, and beneath the groups 404 are boxes 406. As is indicated by the notation 1-N, the control structure 400 may include any number of forms 402, groups 404, and boxes 406. The control structure 400 can also include any other groups and sub-groups that may be needed or desirable.

In an embodiment, a UI service server provides a control structure 400 with data 412, metadata 414, and state information 416 from which a UI can be rendered. User operations with the UI may include higher level user interactions such as, but not limited to, InputValue, InvokeAction, etc. The UI service server then uses the higher level user interactions and calculates a delta of what data, metadata, state, and structure changes need to occur on the UI.

The control structure illustratively provides information on how to layout the forms, groups, boxes, pages, fields, etc. and the flow of the forms and pages (e.g., when to open and close forms or pages as a result of user actions or business logic). Furthermore, the UI service server optionally shows model dialogs, lookup dialogs, etc. as a result of user actions or business logic. Through these abilities, it becomes possible to use the UI web services to create general purpose rich UI clients on any platform.

In certain circumstances, one difference from this solution and previous solutions of exposing web service to an ERP/LOB system is that this service works at the UI level. For example, this solution exposes the UI logic rather than exposing a CRUD interface for working with the data of the UI.

In other embodiments, a business process is task based and will show a sequence of forms or pages to the user that depends on the choices the user makes. A traditional business process web service cannot control the flow of the UI and as such does not expose the information to generically create a UI client for showing this. Additionally, certain embodiments also have fields on pages that have some states (e.g. whether the fields are editable, visible, etc.) that are dependent on business logic. The states will change as the user changes values or performs actions in the UI. Traditional web services do not expose state changes at the UI level and cannot support this. These are just some of the possible features and advantages that may be present in some embodiments.

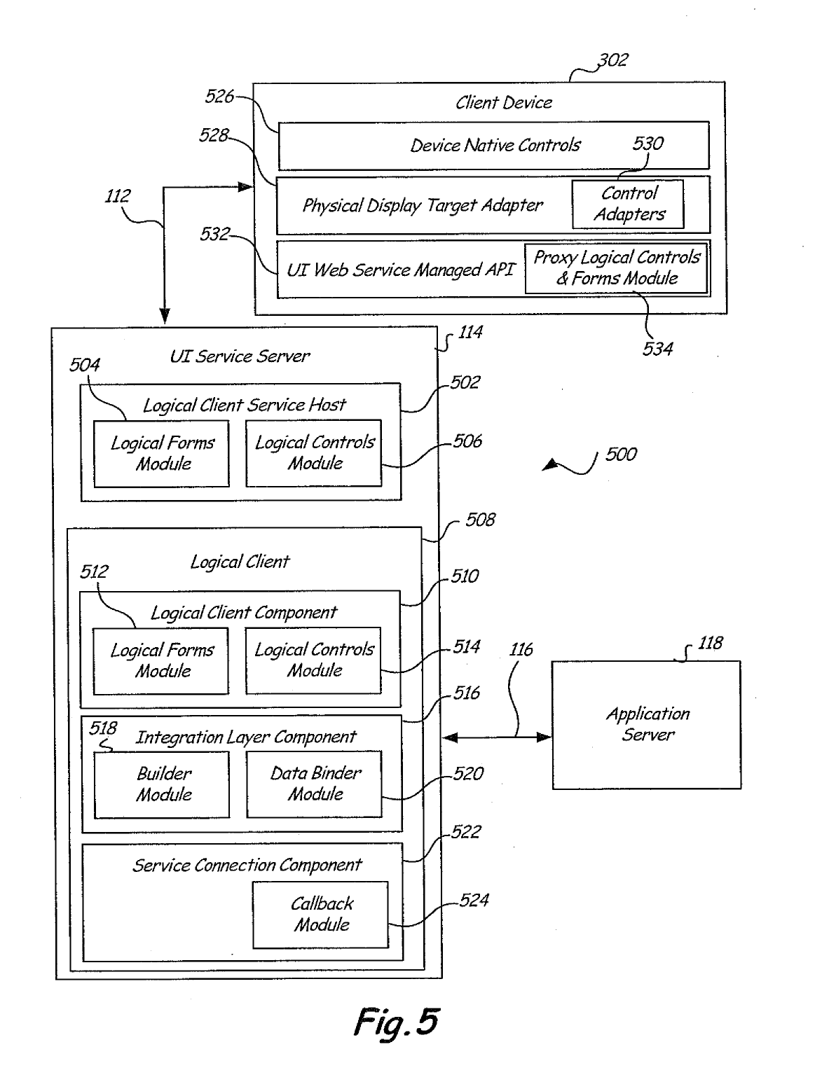

FIG. 5 is a block diagram of another embodiment of a UI system 500. UI system 500 includes a UI service server 114 that communicates with an application server 118 via a network 116, and that communicates with a client device 302 via a network 112. UI service server 114 illustratively includes a logical client service host 502 that has an interactions module 504 and an observers module 506. Logical client service host 502 handles UI web service requests (e.g. start session, end session, etc.).

UI service server 114 may also include a logical client 508. Logical client 508 optionally includes a logical client component 510, an integration layer component 516, and a service connection component 522. Logical client component 510 includes logical forms module 512 and logical controls 514. Logical client component 510 handles all validation and navigation. Integration layer component 516 includes builder module 518 and data binder module 520. Integration layer component 516 builds logical forms from metadata and binds them to application server data. Service connection component 522 includes a callback module 524, and feeds the builders/binders, and provides a callback mechanism.

Client device 302 renders the UI 102 shown and labeled in FIG. 1. Device 302 illustratively includes device native controls 526 (e.g. Windows Phone Silverlight controls), a physical display target adapter 528, and a UI web service managed API 532. The physical display target adapter 528 includes a control adapters module 530 and constructs physical controls matching the display target (e.g. a display of client device 302). The UI web service managed API 532 includes a proxy logical controls and forms module 534, and optionally manages an interface for the UI web service. Embodiments are not however limited to any particular configuration, and can include any combination of one or more of the features described above.

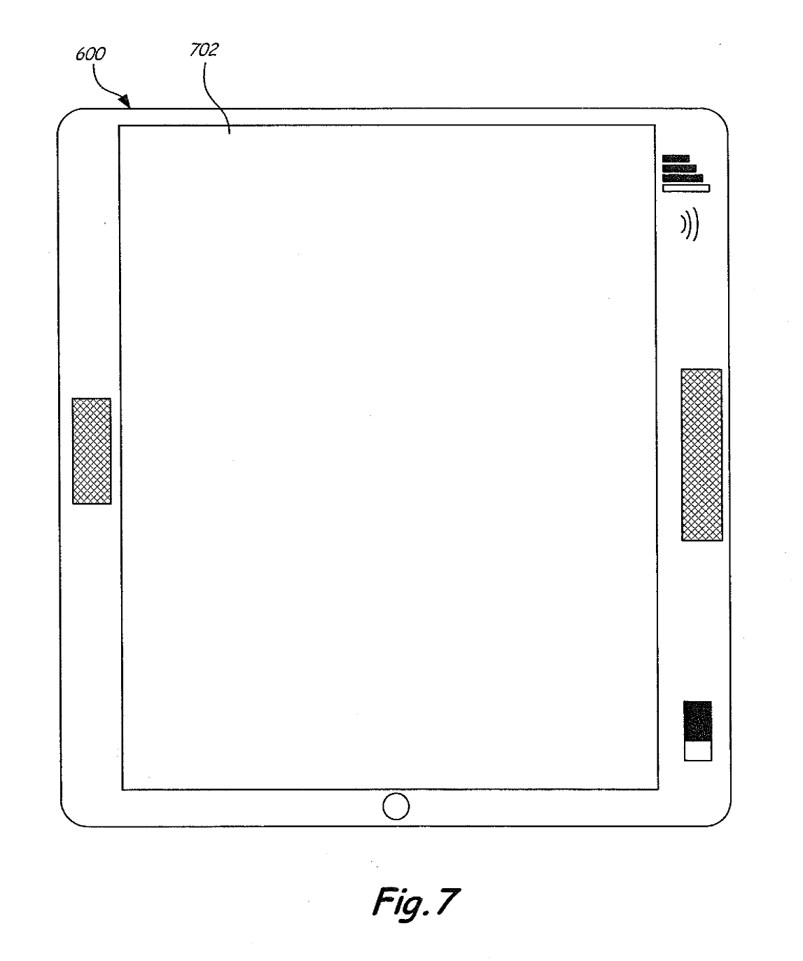

FIGS. 6-10 show various devices that can be used to implement embodiments (e.g. on devices 102, 104, 106, 108, 110, 114, or 118 in FIG. 1). FIGS. 6 and 7 show one embodiment in which the device is a tablet computer 600. In FIG. 6, device 600 optionally includes a memory 621, an SD card interface 615, a location system 627, a processor 617, a clock 625, an i/o system 623, a bus 619, and communications links 613. Memory 621 may include an operating system 629, network settings 631, applications 633, configuration settings 635, a contact or phone book application 643, client business system 624, data store 637, communication drivers 639, and configuration settings 641.

FIG. 7 shows that computer 600 includes a display screen 702 that can be utilized to show a user interface. Screen 702 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

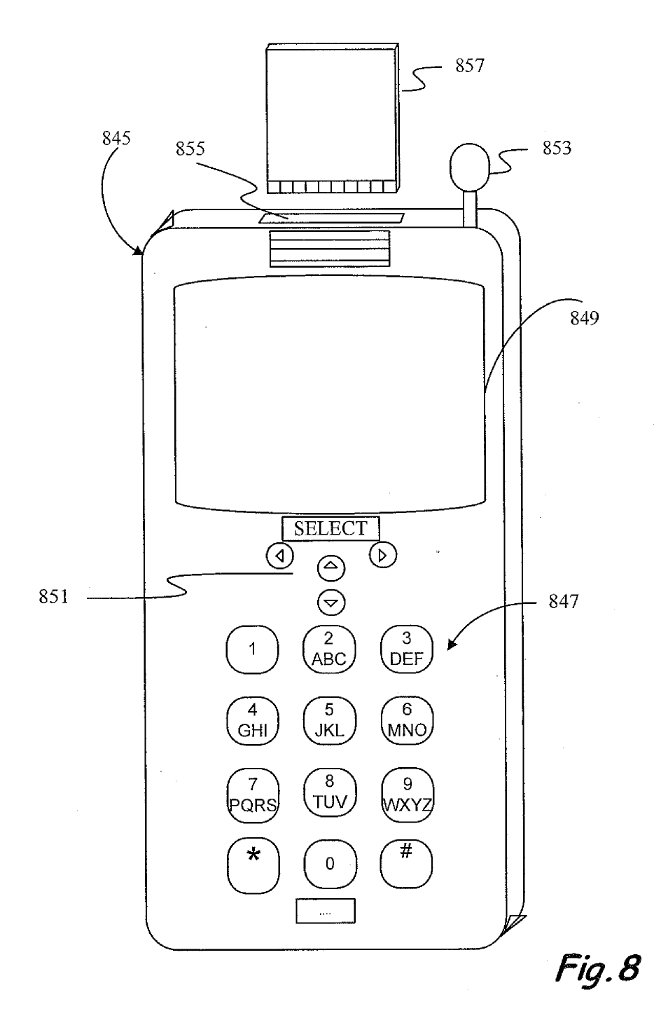

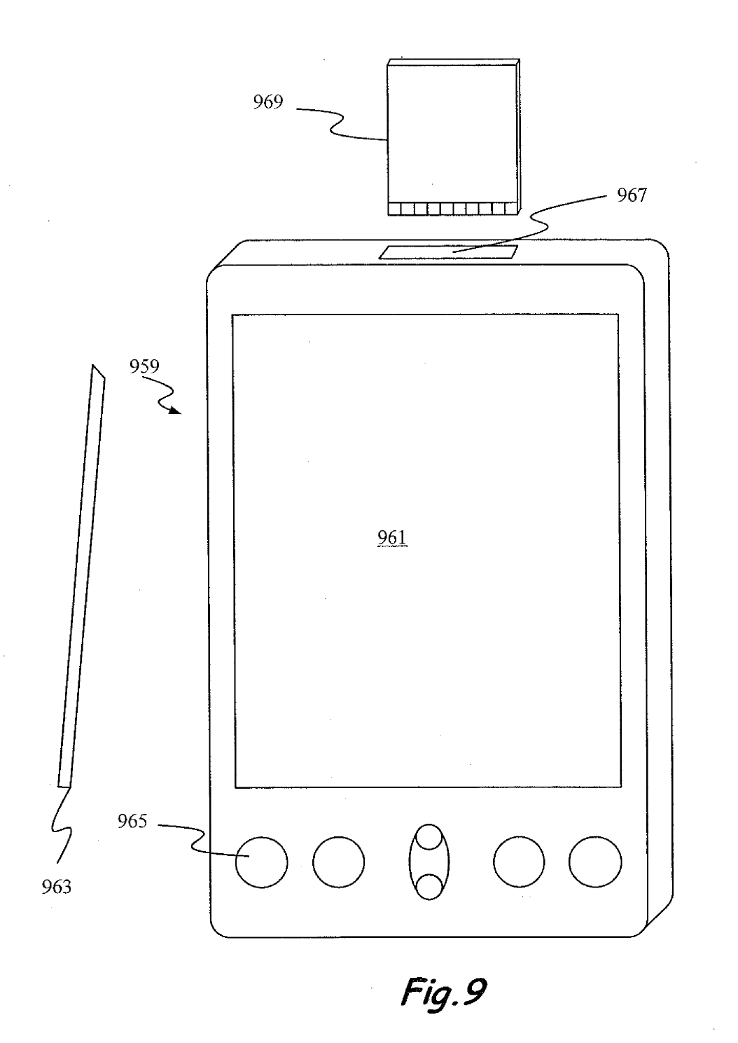

FIGS. 8 and 9 provide additional examples of devices that can be used, although others can be used as well. In FIG. 8, a smart phone or mobile phone 845 is provided as the device. Phone 845 includes a set of keypads 847 for dialing phone numbers, a display 849 capable of displaying images including application images, icons, web pages, photographs, and video, and control buttons 851 for selecting items shown on the display. The phone includes an antenna 853 for receiving cellular phone signals such as General Packet Radio Service (GPRS) and 1Xrtt, and Short Message Service (SMS) signals. In some embodiments, phone 845 also includes a Secure Digital (SD) card slot 855 that accepts a SD card 857.

The mobile device of FIG. 9 is a personal digital assistant (PDA) 959 or a multimedia player or a tablet computing device, etc. (hereinafter referred to as PDA 959). PDA 959 includes an inductive screen 961 that senses the position of a stylus 963 (or other pointers, such as a user's finger) when the stylus is positioned over the screen. This allows the user to select, highlight, and move items on the screen as well as draw and write. PDA 959 also includes a number of user input keys or buttons (such as button 965) which allow the user to scroll through menu options or other display options which are displayed on display 961, and allow the user to change applications or select user input functions, without contacting display 961. Although not shown, PDA 959 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 959 also includes a SD card slot 967 that accepts a SD card 969.

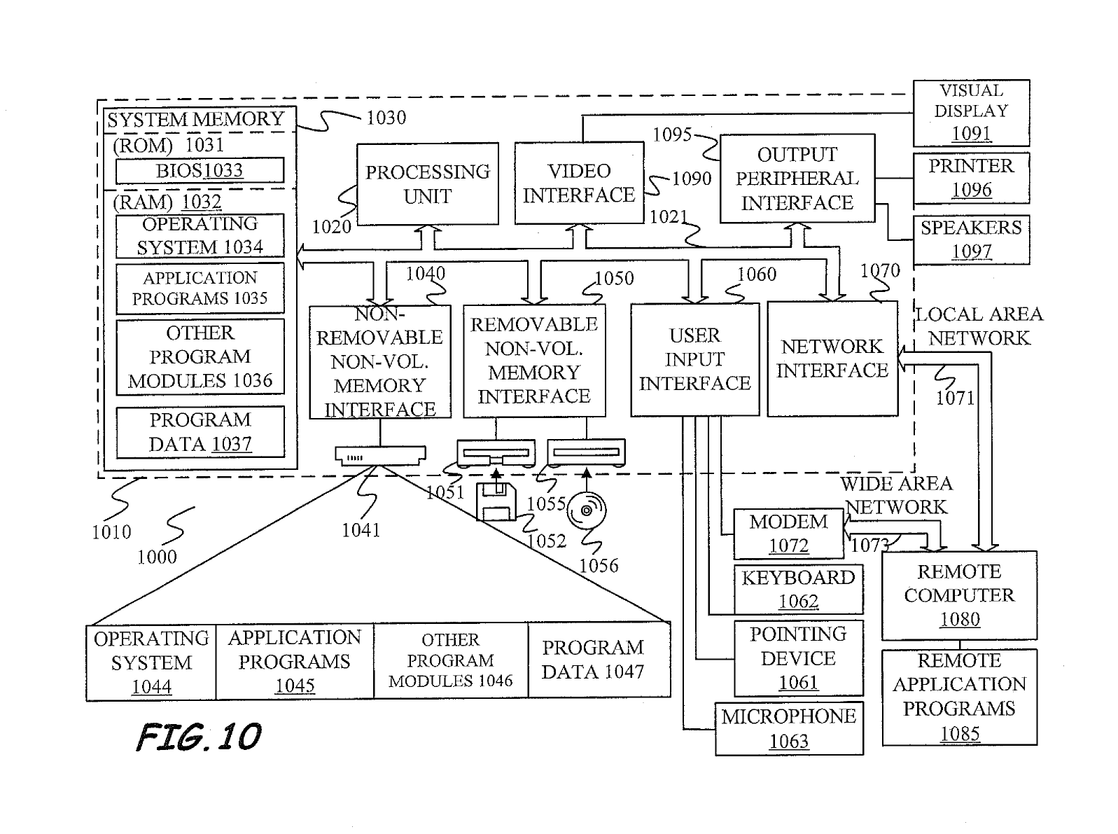

FIG. 10 is one embodiment of a computing environment 1000 in which user interface systems can be deployed. With reference to FIG. 10, an exemplary system for implementing some embodiments includes a general-purpose computing device in the form of a computer 1010. Components of computer 1010 may include, but are not limited to, a processing unit 1020 (which can comprise processor 1006), a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1010 typically includes a variety of computer readable media. Computer readable media can be any available media that can be accessed by computer 1010 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1010. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1030 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies.

A user may enter commands and information into the computer 1010 through input devices such as a keyboard 1062, a microphone 1063, and a pointing device 1061, such as a mouse, trackball or touch pad. Other input devices (not shown) may include a joystick, game pad, satellite dish, scanner, or the like. These and other input devices are often connected to the processing unit 1020 through a user input interface 1060 that is coupled to the system bus, but may be connected by other interface and bus structures, such as a parallel port, game port or a universal serial bus (USB). A visual display 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 is operated in a networked environment using logical connections to one or more remote computers, such as a remote computer 1080. The remote computer 1080 may be a personal computer, a hand-held device, a server, a router, a network PC, a peer device or other common network node, and typically includes many or all of the elements described above relative to the computer 1010. The logical connections depicted in FIG. 10 include a local area network (LAN) 1071 and a wide area network (WAN) 1073, but may also include other networks. Such networking environments are commonplace in offices, enterprise-wide computer networks, intranets and the Internet.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. The modem 1072, which may be internal or external, may be connected to the system bus 1021 via the user input interface 1060, or other appropriate mechanism. In a networked environment, program modules depicted relative to the computer 1010, or portions thereof, may be stored in the remote memory storage device. By way of example, and not limitation, FIG. 10 illustrates remote application programs 1085 as residing on remote computer 1080. It will be appreciated that the network connections shown are exemplary and other means of establishing a communications link between the computers may be used.

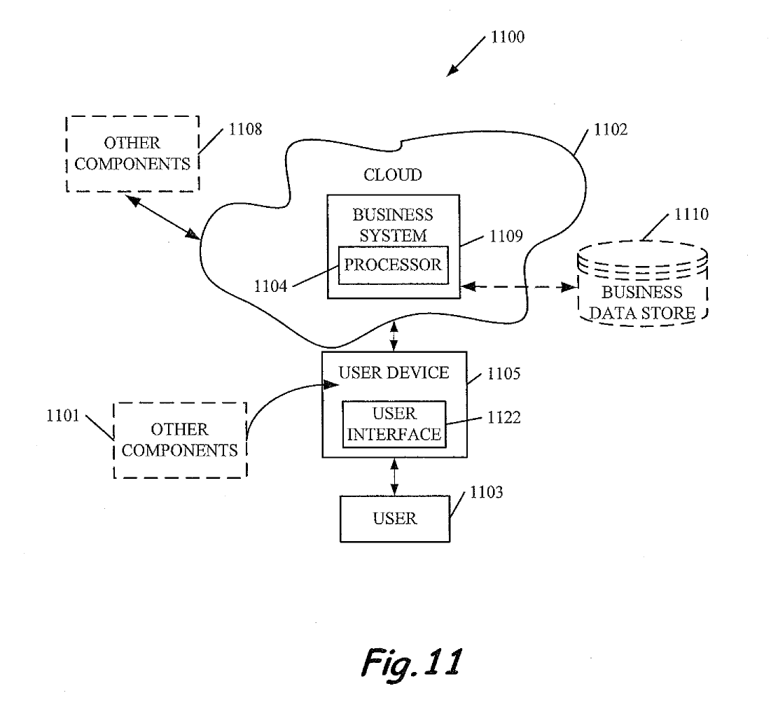

FIG. 11 is a block diagram of one embodiment of a user interface system that includes cloud computing architecture 1100. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of business system 1109 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

The embodiment shown in FIG. 11 specifically shows that business system 1109 is located in cloud 1102 (which can be public, private, or a combination where portions are public while others are private). Therefore, user 1103 uses a user device 1105 to access those systems through cloud 1102.

FIG. 11 also depicts another embodiment of a cloud architecture. FIG. 11 shows that it is also contemplated that some elements of business system 1109 are disposed in cloud 1102 while others are not. By way of example, data store 1110 can be disposed outside of cloud 1102, and accessed through cloud 1102. In another embodiment, some or all of the components 1108 of system 1109 are also outside of cloud 1102. Regardless of where they are located, they can be accessed directly by device 1104, through a network (either a wide area network or a local area network), they can be hosted at a remote site by a service, or they can be provided as a service through a cloud or accessed by a connection service that resides in the cloud. All of these architectures are contemplated herein. FIG. 11 further shows that some or all of the portions of system 1100 can be located on device 1105.

It will also be noted that system 1100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A user-interface service server comprising:
a control structure that is utilized to generate a device dependent user interface;
a communications interface that receives an indication of an interaction with the device dependent user interface; and
a processor that is a component of a computer that generates a delta in response to the interaction, the delta identifying a change to the device dependent user interface.

2. The user-interface service server of claim 1, wherein the delta is transmitted to a client device.

3. The user-interface service server of claim 1, and further comprising:
additional control structures that are associated with different applications.

4. The user-interface service server of claim 1, wherein the processor generates a create, read, update, and delete (CRUD) command based at least in part on the interaction, and wherein the CRUD command is transmitted to an application server utilizing the communications interface.

5. The user-interface service server of claim 1, wherein the control structure has a hierarchical organization.

6. The user-interface service server of claim 5, wherein the hierarchical organization includes groups and boxes organized hierarchically under forms.

7. The user-interface service server of claim 1, wherein the delta identifies a change to the control structure, metadata, state, or data associated with the device dependent user interface.

8. A computer-implemented system comprising:
a control structure that identifies a field on a user interface;
a communications interface that receives an indication of a change in a value for the field;
a processor that is a component of a computer that changes a state of the field based at least in part on the change in the value.

9. The system of claim 8, wherein the communications interface transmits an indication of the change in the state to a client device.

10. The system of claim 8, wherein the control structure identifies a flow of pages of the user interface based at least in part on business logic.

11. The system of claim 8, wherein the communications interface is communicatively coupled to a plurality of client devices that have different form factors.

12. The system of claim 8, wherein the communications interface is communicatively coupled to a plurality of application servers that have different applications.

13. The system of claim 8, wherein the control structure is organized hierarchically.

14. The system of claim 8, wherein the processor generates a create, read, update, and delete command that is transmitted to an application server.

15. A method comprising:
transmitting an indication of a control structure that is configured to be utilized in generating a user interface;
receiving an indication of an interaction with the user interface;
utilizing a processor that is a component of a computer to generate a delta that is generated in response to the indication of the interaction, the delta identifying a change to the control structure or a change to a flow of the user interface; and
transmitting the delta to a client device.

16. The method of claim 15, and further comprising:
receiving an indication of a change to a field of the user interface; and
transmitting a delta that identifies a change of a state of the field.

17. The method of claim 15, and further comprising:
generating a create, read, update, and delete (CRUD) command in response to the interaction; and
transmitting an indication of the CRUD command to an application server.

18. The method of claim 15, and further comprising:
transmitting the indication of the control structure to multiple client devices.

19. The method of claim 15, and further comprising:
storing and transmitting control structures that correspond to a plurality of different applications.

20. The method of claim 15, and further comprising:
hierarchically organizing the control structure.
